(19) United States
(12) Patent Application Publication
(10) Pub. No.: US 2012/0261432 A1
(43) Pub. Date: Oct. 18, 2012

(54) CARTONS FOR DISPERSING SYSTEMS

(76) Inventor: Bradford J. WALLING, Chesterfield, VA (US)

(21) Appl. No.: 13/088,502

(22) Filed: Apr. 18, 2011

(51) Int. Cl. B65D 83/00; B65D 5/72; B65G 59/00; B65D 5/54

(52) U.S. Cl. 221/1; 229/242; 229/125.12; 221/282; 221/32

(57) ABSTRACT

A carton for containing and dispensing a plurality of products is disclosed that comprises: a plurality of panels that define an internal volume; a trap door defined in at least one panel of the plurality of panels and separable from the panel along at least one weakened line to form an opening in the panel; and an insert strip positioned in the internal volume at least partially over the trap door. The insert strip retains the plurality of products within the internal volume of the carton after the trap door is separated from the panel. The products may then be dispensed through the opening by at least partially removing the insert strip from the internal volume.

### BACKGROUND OF THE DISCLOSURE

The present disclosure generally relates to improved cartons for holding and dispensing the packaged products. More specifically, the present disclosure relates to improved cartons for use with dispensing systems.

### SUMMARY OF THE DISCLOSURE

A carton for containing and dispensing a plurality of products is disclosed that comprises: a plurality of panels that define an internal volume; a trap door defined in at least one panel of the plurality of panels and separable from the panel along at least one weakened line to form an opening in the panel; and an insert strip positioned in the internal volume at least partially over the trap door. The insert strip retains the plurality of products within the internal volume of the carton after the trap door is separated from the panel. The products may then be dispensed through the opening by at least partially removing the insert strip from the internal volume.

### BRIEF DESCRIPTION OF THE DRAWINGS

FIG. 1 shows a plain view of a blank for forming the carton according to one embodiment of the present disclosure;

FIG. 2 is a perspective view illustrating the carton formed from the blank shown in FIG. 1;

FIG. 3 is a perspective view illustrating the carton shown in FIG. 2 when the carton is flipped upside down;

FIG. 4 illustrates the opening of the trap door by pushing finger through the aperture (FIG. 4A) and tearing away the trap door (FIG. 4B) such that the packaged products inside the carton are exposed but yet retained in the carton by the insert strip (FIG. 4C);

FIG. 5 demonstrates the insert strip apart from the carton to show the 90 degree fold line at the rear end and the pull tab at the from end of the insert strip; and

FIG. 6 illustrates the opening of the aperture on the front end of the bottom panel of the carton by pushing finger through the aperture and tearing away the frangible line (FIG. 6A) to gain access to the pull tab of the insert strip, which upon pulling the insert strip (FIG. 6B) the products in the cartons are freely exposed (FIG. 6C).

### DESCRIPTION OF THE DISCLOSURE

The present disclosures now will be described more fully hereinafter, but not all embodiments of the disclosure are necessarily shown. While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof.

The disclosed carton for containing and dispensing a plurality of products comprises:
(a) a plurality of panels that define an internal volume;
(b) a trap door defined in at least one panel of the plurality of panels, wherein the trap door is separable from the panel along at least one weakened line to form an opening in the panel; and
(c) an insert strip positioned in the internal volume at least partially over the trap door;
wherein the insert strip retains the plurality of products within the internal volume after the trap door is separated from the panel to from the opening, and
wherein at least one product of the plurality of products is dispensed through the opening when the insert strip is at least partially removed from the internal volume.

In one embodiment of the present disclosure, the carton comprises:
(a) a plurality of panels including a top panel, a bottom panel, a first side panel, and a second side panel, each panel including a front end and a rear end;
(b) a front panel connecting the front ends of the first and second side panels;
(c) a rear panel connecting the rear ends of the first and second side panels;
(d) a trap door defined in at least one panel of the plurality of panels, wherein the trap door is separable from the panel along at least one weakened line to form an opening in the panel;
(e) an insert strip removably attached to the bottom panel, the insert strip including a pull tab at its front end;
(f) a weakening feature on the front end of the bottom panel which upon removal exposes the pull tab of the insert strip; wherein
upon removal of the trap door, the products are exposed but yet retained inside the carton by the insert strip, and
upon engaging the carton with the dispensing system and removing the insert strip, the products freely fall down and out of the carton into the dispersing system.

In one embodiment, the disclosed carton comprises:
(a) a plurality of panels including a top panel, a bottom panel, a first side panel, and a second side panel, each panel including a front end and a rear end;
(b) a front panel connecting the front ends of the first and second side panels;
(c) a rear panel connecting the rear ends of the first and second side panels;
(d) a trap door defined by a weaken line on the first side panel, the bottom panel, and the second side panel;
(e) an insert strip removably attached to the bottom panel, the insert strip including a 90 degree fold line at its rear end and a pull tab at its front end;
(f) a weakening feature on the front end of the bottom panel which upon removal exposes the pull tab of the insert strip; wherein
upon removal of the trap door, the products are exposed but yet retained inside the carton by the insert strip, and
upon engaging the carton with the dispensing system and removing the insert strip, the products freely fall down and out of the carton into the dispersing system.

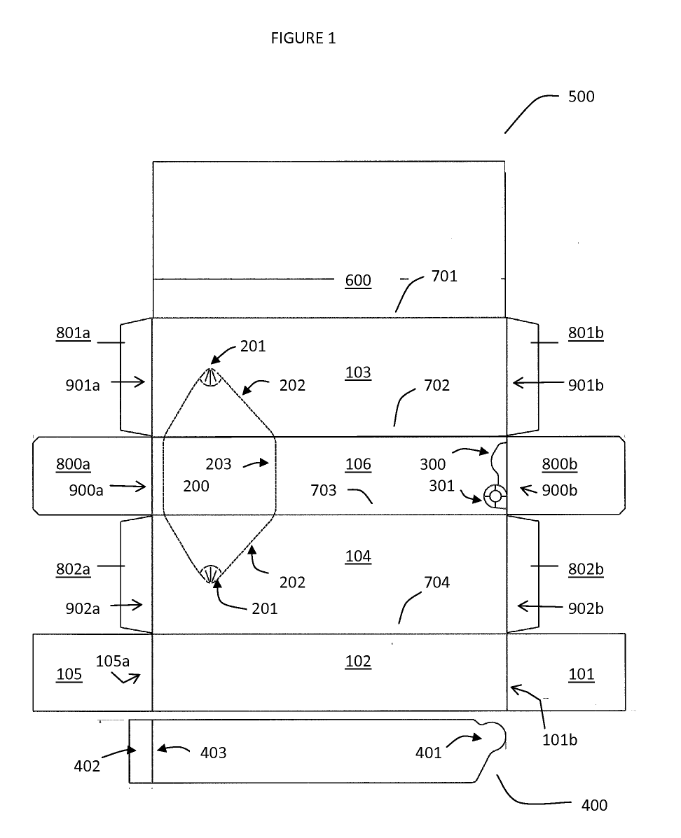

Referring to FIG. 1, there is shown a blank for forming the improved carton according to one embodiment of the present disclosure. The blank 100 comprises of a main body component 500 and an insert strip 400.

### The Main Body of the Blank

The main body 500 comprises in series, a glue flap 600, a first side panel 103, a bottom panel 106, a second side panel 104 and a top panel 102 hingedly connected one to the next in series along fold lines 701, 702, 703, and 704 respectively.

Along each longitudinal edge, there comprises a series of end panels and flaps for forming a front end panel and a rear end panel of the carton. Each end panel and flap is identical and therefore like references has been used, with the affix “a” or “b.” Therefore, only one end panel will now be described in any greater detail.

The rear end panel (i.e., the left end as viewed in FIG. 1) comprises a rear end panel 105 hingedly connected to top panel 102 along fold line 105a; a support end panel 800a hingedly connected to bottom panel 106 along fold line 900a; support flap 801a hingedly connected to first side panel 103 along fold line 901a; and support flap 802a hingedly connected to second side panel 104 along fold line 902a. The support end panel 800a and support flaps (801a and 802a) are engaged with and support the rear panel 105.

In FIG. 1, there comprises a trap door panel 200 in a “shark's mouth” shape formed on the first side panel 103, a bottom panel 106, and a second side panel 104 toward the rear end panel. The trap door panel 200 is frangibly connected to the respective first and second side panels (103 and 104) by a weakened or frangible line 202, and to the bottom panel 106 by a weakened or frangible line 203. The frangible lines 202 and 203 are shaped to define the trap door 200 forming “shark's mouth” shape. In the embodiment shown in FIG. 1, there further comprises one or more tear initiation means in the form of finger punch-through arrangement for grasping the trap door 200. When desired, the aperture may be positioned in the void space between the packaged products. In FIG. 1, there further comprises aperture 201 at the triangle point of each franglible line 202 on the first and second side panels 103 and 104, wherein the trap door 200 is removed from the carton by using a cross-tearing motion initiated at the aperture 201 at either side wall panel.

In FIG. 1, there further comprises one or more tear initiation means in the form of finger punch-through arrangement on the bottom panel 106 toward the front end panel. In the embodiment shown in FIG. 1, an aperture 300 and tearing line 301 are incorporated onto the bottom panel 106. The aperture 300 shown in FIG. 1 is in a shape of star dust. However, it is to be understood that other shapes of aperture and/or tearing line may be used in the disclosed cartons without departing from the scope of the present disclosure.

### The Insert Strip of the Blank

The insert strip 400 includes a front end 401 in a form of pull tab and a back end 402 that hingedly connected to the insert strip 400 along fold line 403. When the blank is formed into the disclosed carton, the insert strip 400 is placed over bottom panel 106 such that the fold line 403 of the insert 400 is align on top of the fold line 900a of the main component 500, and the pull tab 402 of in the inset 400 is on top of the weakened or frangible line 301 of the main component 500.

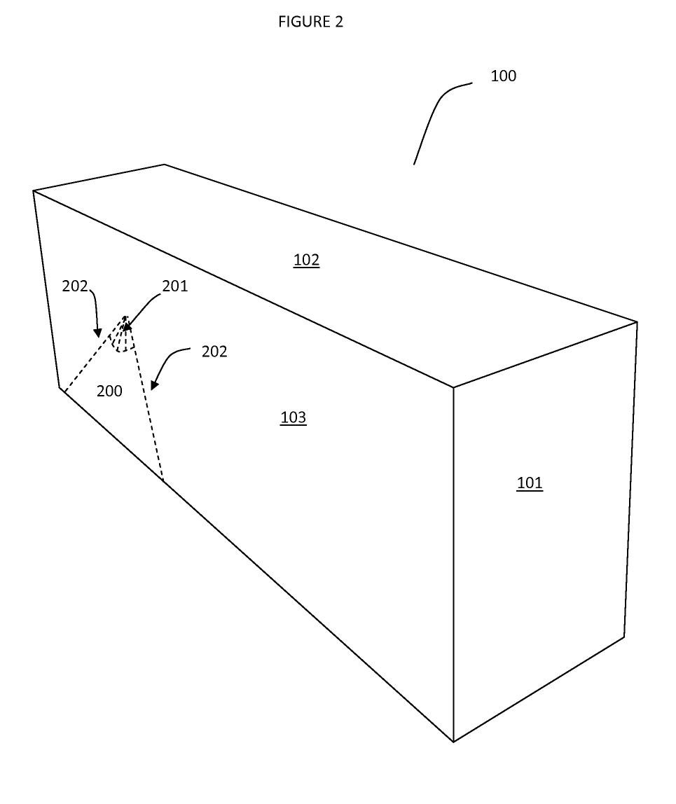

FIG. 2 shows illustrates the disclosed carton formed from the blank of FIG. 1, showing the front end panel 101, the top panel 102, the first side panel 103 and a partial portion of the “shark's mouth” trap door 200 on the first side panel 103. The trap door 200 is defined by a pair of weakened or frangible line 202 that are jointed at an aperture 201.

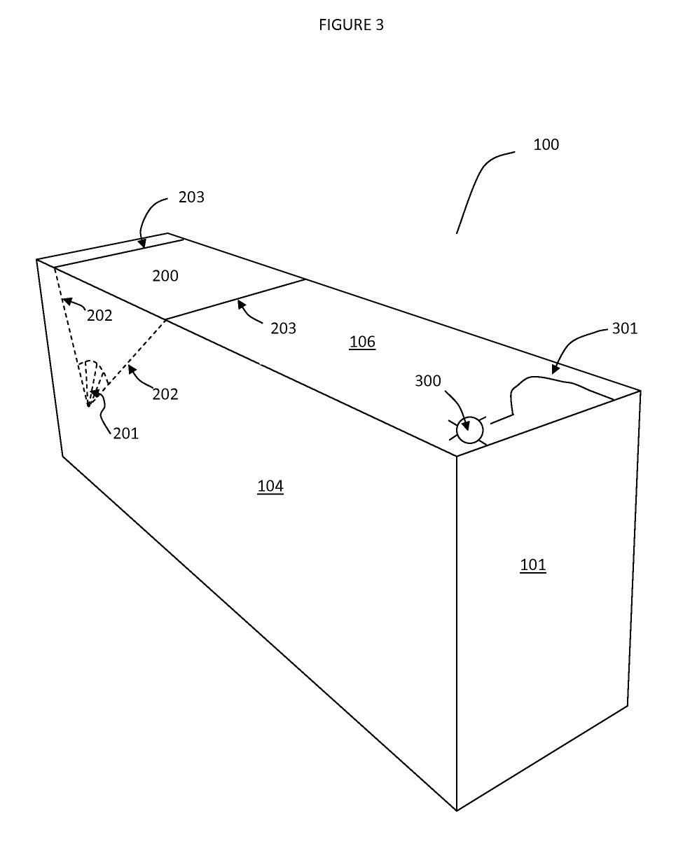

Referring to FIG. 3, the disclosed carton of FIG. 2 is flipped upside down to show the front end panel 101 the bottom panel 106 the second side panel 104, and a partial portion of the “shark's mouth” trap door 200 toward the rear end panel on the bottom panel 106 and the second side panel 104. The trap door 200 portion on the second side panel 104 is defined by a pair of weakened or frangible line 202 that are jointed at an aperture 201, and the trap door 200 portion on the bottom panel 106 is defined by a pair of weakened or frangible line 203. In FIG. 3, on the bottom panel 106 towards the front end panel 101, there further comprises an aperture 300 in a shape of star dust and a weakened or frangible line 301 that is peripheral to the aperture 300.

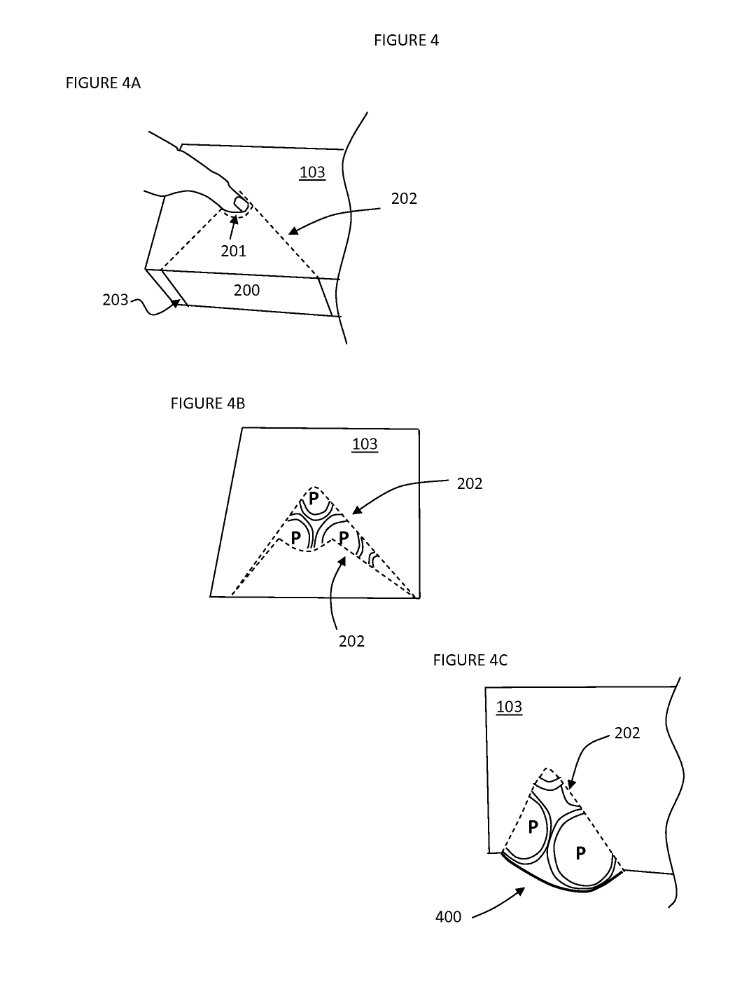

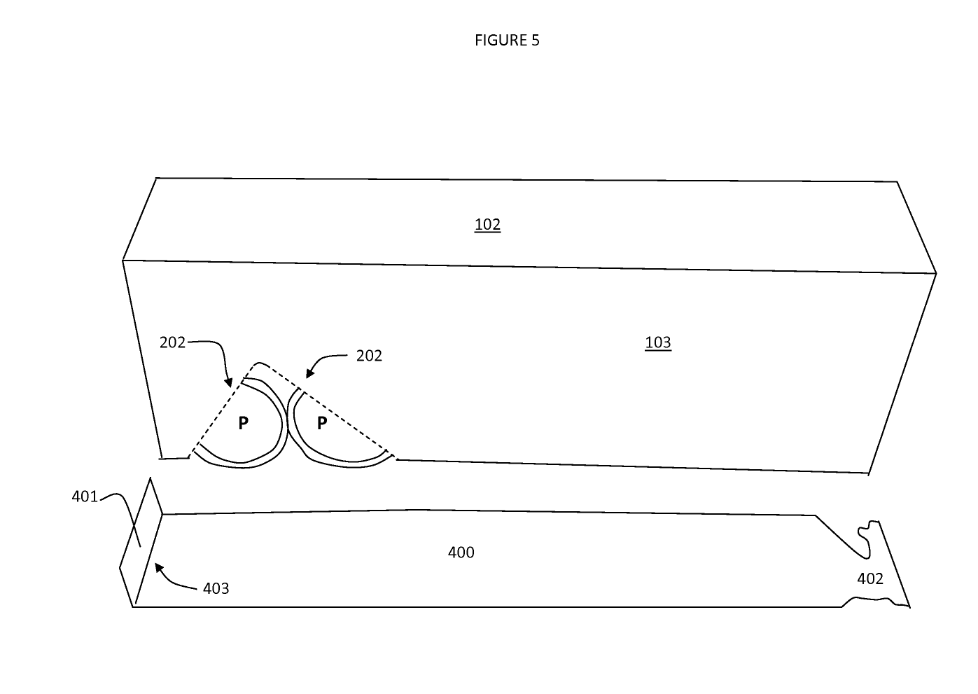

FIG. 4 demonstrates the embodiment of disclosed carton shown in FIG. 2 when in use. The trap door is opened by punching a finger through the aperture 201 (FIG. 4A) and making a cross tearing motion along the weakening or frangible lines 202 and 203 (FIG. 4B). Once the trap door 200 is removed from the carton, the products P are retained in the opened carton by the insert strip 400. The fold line 403 on the insert 400 is folded at a 90 degree bend once the blank (400 and 500) are formed into the carton, such that the insert strip 400 is able to prevent the products P from falling out of the carton through the opening once the trap door 200 is removed. (FIG. 5)

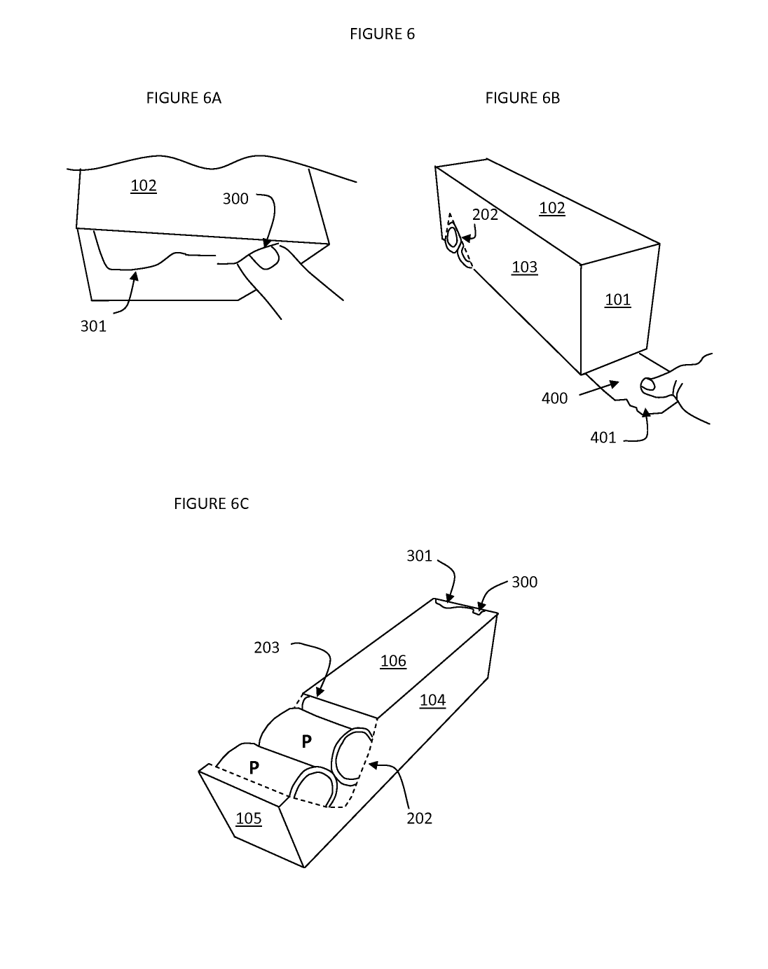

Referring to FIG. 6, after the opening and removing of the “shark's mouth” trap door 200, the aperture 300 on the bottom panel 106 towards the front end panel 101 is engaged by punching a finger through the aperture 300 (FIG. 6A) to initiate the tearing of the weakening or frangible line 301 such that the pull tab 401 of the insert strip 400 is now exposed. Then, as shown in FIG. 6B, the exposed pull tab 401 is pulled to separate the insert strip 400 from the carton. Once the insert strip 400 is removed from the carton, the products P are exposed (FIG. 6B) and now fall freely out of the carton through the opening of the “shark's mouth” trap door 200.

It is to be understood that only some embodiments of the disclosed cartons are shown. One skilled in arts readily recognizes that other shapes and sizes of cartons may be used. Additionally, the present disclosure is not limited in anyway by the shapes and sizes of the trap door, the tearing initiation means on the trap door and/or the insert strip, and/or the pull tab(s) on the insert strip. These features may be modified to accommodate the end use applications of the cartons.

In the illustrated embodiments, a two-piece blank is used to form the disclosed carton. Nonetheless, one skilled in the arts recognizes that a unitary blank or more than two-piece blank may be employed to form the disclosed carton.

The blanks and cartons may be formed from paperboard or other foldable sheet materials, for example plastics material or the like, to which there have been added cut and fold lines.

The disclosed cartons may be used as containers for goods in a variety of forms. These forms include, but are not limited to, cans and bottles.

The disclosed carton may facilitate the dispensing of product via a static dispensing system. In use, the trap door is removed to reveal an opening that allows the products inside the carton to dispense through the trap door opening, out of the carton and into the dispenser. The opening of the trap door may be initiated by engaging in the aperture on the trap door. Upon removing the trap door, the operator would slide the resulting carton into the dispensing system with the trap door positioned on the rear end of the carton. The goods packaged inside the carton would continue to be retained inside the carton, as the insert strip prevents them from falling out of the carton through the opened trap door. Then, the insert strip may be removed from the carton by pushing a finger up through the aperture on the bottom panel toward the front end panel of the carton, and pulling away the insert strip holding the packaged products in place. Once the insert strip is removed from the carton, the products freely disperse down and out to the disperser via the opened trap door.

While the invention has been described by reference to various specific embodiments, it should be understood that numerous changes may be made within the spirit and scope of the inventive concepts described. It is intended that the invention not be limited to the described embodiments, but will have full scope defined by the language of the following claims.

We claim:

1. A carton for containing and dispensing a plurality of products, the carton comprising:
(a) a plurality of panels that define an internal volume;
(b) a trap door defined in at least one panel of the plurality of panels, wherein the trap door is separable from the panel along at least one weakened line to form an opening in the panel; and
(c) an insert strip positioned in the internal volume at least partially over the trap door;
wherein the insert strip retains the plurality of products within the internal volume after the trap door is separated from the panel to from the opening, and
wherein at least one product of the plurality of products is dispensed through the opening when the insert strip is at least partially removed from the internal volume.

2. The carton of claim 1 suitable for use with a dispensing system, the carton comprising:
(a) a plurality of panels including a top panel, a bottom panel, a first side panel, and a second side panel, each panel including a front end and a rear end;
(b) a front panel connecting the front ends of the first and second side panels;
(c) a rear panel connecting the rear ends of the first and second side panels;
(g) a trap door defined in at least one panel of the plurality of panels, wherein the trap door is separable from the panel along at least one weakened line to form an opening in the panel;
(h) an insert strip removably attached to the bottom panel, the insert strip including a pull tab at its front end;
(i) a weakening feature on the front end of the bottom panel which upon removal exposes the pull tab of the insert strip; wherein
upon removal of the trap door, the products are exposed but yet retained inside the carton by the insert strip, and
upon engaging the carton with the dispensing system and removing the insert strip, the products freely fall down and out of the carton into the dispersing system.

3. The carton of claim 2, wherein the trap door further comprises a trap door aperture locating on at least one of the side panels.

4. The carton of claim 2, wherein the trap door is in a shape of shark's mouth.

5. The carton of claim 2, wherein the weakening feature on the front end of the bottom panel comprises a front aperture for pushing through by a finger, and a front weakening line peripheral to the front aperture.

6. The carton of claim 5, wherein the insert aperture is in a shape of star dust.

7. A blank used to form the carton of claim 1.

8. The blank of claim 7 derived from a material including a member selected from a group consisting of paperboard, cardboard, plastics, and combinations thereof.

9. A blank used to form the carton of claim 2.

10. The blank of claim 9 derived from a material including a member selected from a group consisting of paperboard, cardboard, plastics, and combinations thereof.

11. A dispersing system including the Carton of claim 1.

12. A dispersing system including the Carton of claim 2.

13. A method of dispensing products, comprising steps of:
preparing a carton for containing and dispensing a plurality of products, the carton comprising:
(a) a plurality of panels that define an internal volume,
(b) a trap door defined in at least one panel of the plurality of panels, wherein the trap door is separable from the panel along at least one weakened line to form an opening in the panel, and
(c) an insert strip positioned in the internal volume at least partially over the trap door, wherein the insert strip retains the plurality of products within the internal volume after the trap door is separated from the panel to from the opening;
removing the trap door from the carton along the defined weaken line to create the opening;
removing the insert strip at least partially from the internal volume to dispense at least one product of the plurality of products through the opening.

14. The method of claim 13, comprising steps of:
preparing a carton for containing and dispensing a plurality of products, the carton comprising:
(a) a plurality of panels including a top panel, a bottom panel, a first side panel, and a second side panel, each panel including a front end and a rear end,
(b) a front panel connecting the front ends of the first and second side panels,
(c) a rear panel connecting the rear ends of the first and second side panels,
(d) a trap door defined in at least one panel of the plurality of panels, the trap door being separable from the panel along at least one weakened line to form an opening in the panel,
(e) an insert strip removably attached to the bottom panel, the insert strip including a pull tab at its front end,
(f) a weakening feature on the front end of the bottom panel which upon removal exposes the pull tab of the insert strip,
removing the trap door from the carton along the defined weaken line to expose the products yet retain the products inside the carton by the insert strip;
connecting the carton to the dispensing system;
engaging the weakening feature on the front end of the bottom panel to expose the pull tab on the insert strip; and
pulling the pull tab on the insert strip away from the carton such that the products freely fall down and out of the carton into the dispersing system.

15. The method of claim 13, the trap door including a trap door aperture, wherein the method further comprising steps of:
pushing finger through the trap door aperture; and
cross tearing the trap door from the carton along the defined weaken line.

16. The method of claim 14, the trap door including a trap door aperture, wherein the method further comprising steps of:
pushing finger through the trap door aperture; and
cross tearing the trap door from the carton along the defined weaken line.

17. The carton of claim 14, the weakening feature on the front end of the bottom panel including a front aperture and a front weaken line peripheral to the front aperture, wherein the method further comprising steps of:
pushing finger through the front aperture; and
cross tearing along the front weaken line to expose the pull tab on the insert strip.
